(19) United States
(12) Patent Application Publication
(10) Pub. No.: US 2025/0023358 A1
(43) Pub. Date: Jan. 16, 2025

(54) SCAN CONTROL DEVICE

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/438,699

(22) Filed: Feb. 12, 2024

(30) Foreign Application Priority Data
Jul. 11, 2023 (JP) 2023-113951

(51) Int. Cl. H02J 3/38; B60L 8/00; G01S 3/786; H02S 20/30

(52) U.S. Cl. CPC H02J 3/38; B60L 8/003; G01S 3/7862; H02S 20/30

(57) ABSTRACT

Solar modules including a solar panel, a sensor for acquiring a power generation state of the solar panel, and a power generation control unit for controlling power generation of the solar panel based on the power generation state are connected to each other. A scan control device for controlling a scan process for scanning an output voltage of each solar panel executed by each power generation control unit to search for a maximum power point includes a determination unit for determining whether or not a power generation state of each solar panel satisfies a predetermined condition, and an instruction unit for instructing a power generation control unit of a solar panel to be controlled based on a result of a scan process in a specific solar module when there is a solar module to be controlled whose power generation state of the solar panel does not satisfy the predetermined condition.

### CROSS-REFERENCE TO RELATED APPLICATION

This application claims priority to Japanese Patent Application No. 2023-113951 filed on Jul. 11, 2023, incorporated herein by reference in its entirety.

### BACKGROUND

### 1. Technical Field

The present disclosure relates to a scan control device included in a solar charging system mounted on a vehicle or the like.

### 2. Description of Related Art

Japanese Unexamined Patent Application Publication No. 2020-141545 (JP 2020-141545 A) discloses an in-vehicle solar charging system provided with a plurality of solar panels. In the solar charging system described in JP 2020-141545 A, each solar control device provided for each solar panel performs Maximum Power Point Tracking (MPPT) control on the solar panel to be controlled by the device. In this MPPT control, in order to search for the maximum power point with high accuracy when the output voltage of the solar panel changes due to an environmental change such as a change in solar radiation condition, a scanning process for scanning the output voltage of the solar panel is performed to find an optimum point on P-V curve.

### SUMMARY

In the solar charging system described in JP 2020-141545 A, a plurality of solar control devices independently performs MPPT control on the control target solar panels, but a cooperative process is not performed among the plurality of solar control devices. Therefore, if there is a solar module that cannot accurately follow the maximum power point of the solar panel due to a failure of a sensor, an abnormality in control, or the like, the scanning accuracy of the solar panel is reduced, the scanning frequency is increased, and the scanning time is increased. In addition, there is an issue that the power generation efficiency of the entire solar charging system is lowered.

The present disclosure has been made in view of the above issue, and an object of the present disclosure is to provide a scan control device capable of suppressing a reduction in power generation efficiency of the entire solar charging system even when there is a solar module that cannot accurately follow a maximum power point of a solar panel.

In order to address the above issue, an aspect of the technique of the present disclosure provides
a scan control device that controls a scanning process in a system in which a plurality of solar modules is connected, the solar modules each including a solar panel, a sensor that acquires a power generation state of the solar panel, and a power generation control unit that controls power generation by the solar panel based on the power generation state of the solar panel, the scanning process being executed by each power generation control unit to search for a maximum power point by scanning an output voltage of each solar panel, the scan control device including:
a determination unit that determines whether the power generation state of each solar panel meets a predetermined condition; and
an instruction unit that, when there is a control target solar module for which it is determined by the determination unit that the power generation state of the solar panel does not meet the predetermined condition, instructs the power generation control unit of the control target solar module to control the power generation by the solar panel based on a result of the scanning process for a specific solar module that is different from the control target solar module.

According to the scan control device of the present disclosure, it is possible to suppress a reduction in power generation efficiency of the entire solar charging system even when there is a solar module that cannot accurately follow a maximum power point of a solar panel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a solar charging system including a scan control device according to an embodiment;

FIG. 2A is a diagram illustrating an example in which a plurality of solar panels is mounted on a vehicle in a multi-system configuration;

FIG. 2B shows an example of multi-junction mounting of solar panels on vehicles; and

FIG. 3 is a flowchart of scan process control performed by the scan control device.

### DETAILED DESCRIPTION OF EMBODIMENTS

The scan control device of the present disclosure applies a scan process of another solar module having no MPPT control issue to power generation control of a solar module that does not perform MPPT control successfully when there are solar modules that do not perform MPPT control successfully, in the plurality of solar modules. This control suppresses a decrease in the power generation efficiency of the solar charging system as a whole.

Hereinafter, an embodiment of the present disclosure will be described in detail with reference to the drawings.

### Embodiment

### Configuration

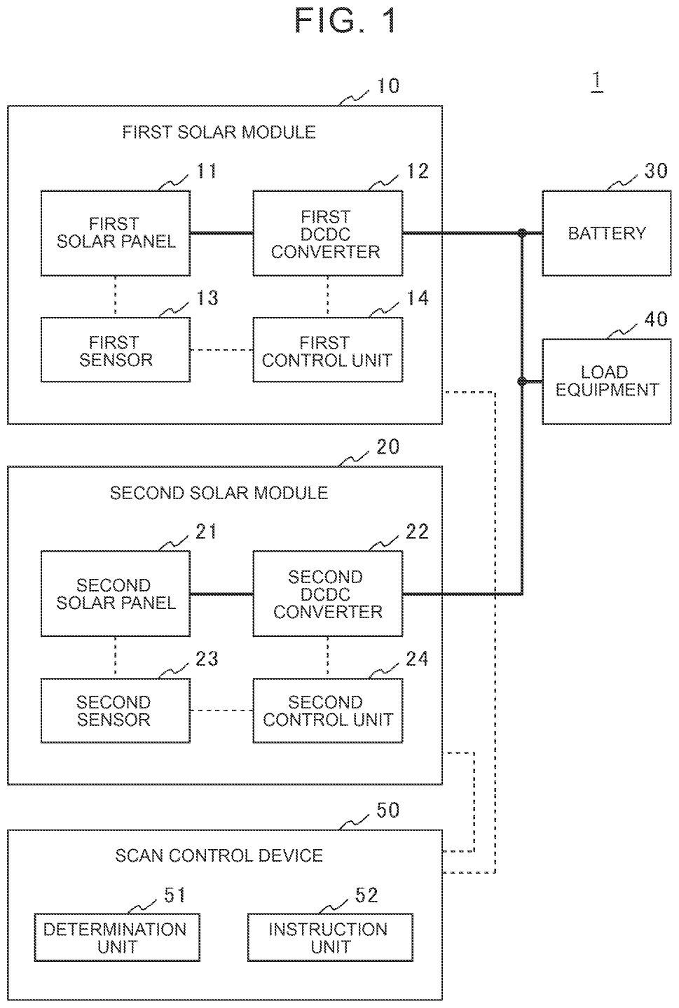

FIG. 1 is a block diagram illustrating a schematic configuration of a solar charging system 1 including a scan control device 50 according to an embodiment of the present disclosure. The solar charging system 1 illustrated in FIG. 1 includes a first solar module 10, a second solar module 20, a battery 30, a load device 40, and a scan control device 50. In FIG. 1, a connection line through which power is transmitted is indicated by a thick solid line, and a connection line through which control signals, detection values, and the like other than power are transmitted and received is indicated by a dotted line. The solar charging system 1 can be mounted on vehicles such as, for example, hybrid electric vehicle (HEV), plug-in hybrid electric vehicle (PHEV), and battery electric vehicle (BEV).

Each of the first solar module 10 and the second solar module 20 is a power generation device that generates electric power by being irradiated with sunlight. The first solar module 10 and the second solar module 20 can output the generated electric power to the battery 30, the load device 40, or the like connected to the first solar module 10 and the second solar module 20. In FIG. 1, an example in which the solar charging system 1 includes two of the first solar module 10 and the second solar module 20 has been described. However, the number of solar modules is not limited to two, and may be three or more.

The first solar module 10 includes a first solar panel 11, a first DCDC converter 12, a first sensor 13, and a first control unit 14 in a configuration. The second solar module 20 includes a second solar panel 21, a second DCDC converter 22, a second sensor 23, and a second control unit 24 in a configuration.

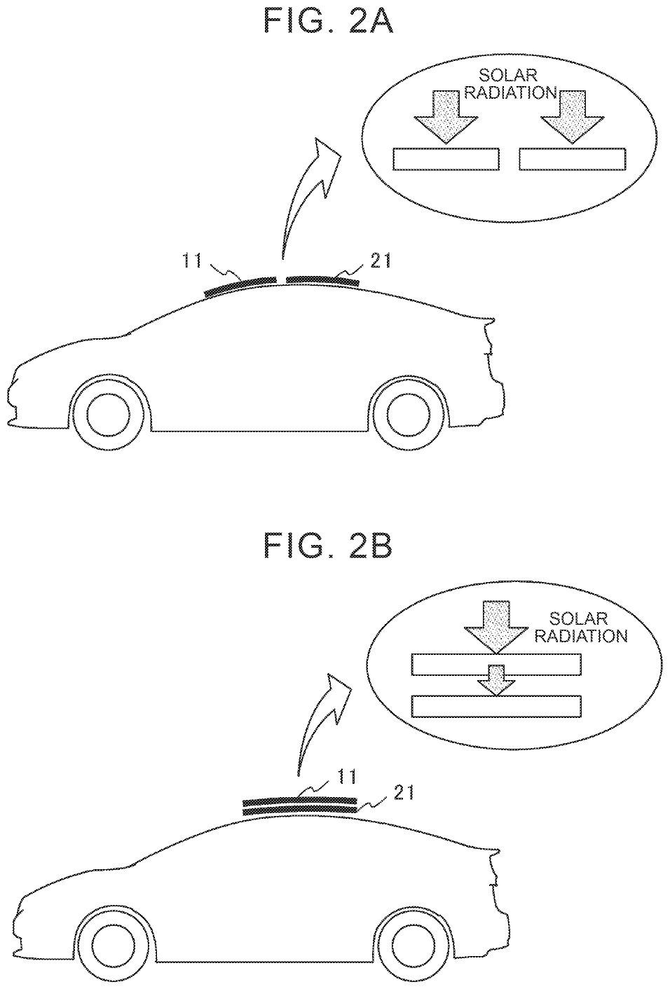

Each of the first solar panel 11 and the second solar panel 21 is a device capable of generating electric power corresponding to the irradiation amount of sunlight, and is typically an aggregate of solar cells. The first solar panel 11 and the second solar panel 21 may be arranged at different locations in a planar manner, or may be arranged at the same location in a three-dimensional manner. In FIG. 2A, the first solar panel 11 and the second solar panel 21 are arranged side by side on the roof of the vehicle (multi-system configuration). In FIG. 2B, the first solar panel 11 and the second solar panel 21 are placed on the roof of the vehicle (multi-junction structure).

It is desirable that the first solar panel 11 and the second solar panel 21 are installed at locations correlated with solar radiation conditions. The correlation between solar radiation conditions can be expressed by the fact that both ways of being exposed to sunlight are nearly equivalent to each other, or one way of being exposed to sunlight can be estimated from the other way of being exposed to sunlight. More specifically, for example, in the case of a multi-system structure (FIG. 2A) in which panels are arranged at different locations, it can be said that the normal direction or curvature of the surface of the first solar panel 11 is correlated with the normal direction or curvature of the surface of the second solar panel 21 if the normal direction or curvature of the surface coincides or approximates with each other. In the case of installing three or more solar panels, it is desirable that each solar panel has a correlation with solar radiation conditions with at least one other solar panel. On the other hand, in the case of a multi-junction structure (FIG. 2B) in which the panels are placed on top of each other at the same location, the normal direction and the curvature of the surfaces of the first solar panel 11 and the second solar panel 21 already coincide with each other. Therefore, it can be said that there is a correlation in the solar radiation situation. However, in the case of such a multi-junction structure, the amount of light that passes through the first solar panel 11 and reaches the second solar panel 21 is smaller than the amount of light that is received by the first solar panel 11. Therefore, in order to estimate the amount of light received by the second solar panel 21 (or vice versa) from the amount of light received by the first solar panel 11, the light transmittance, the light attenuation rate, and the like of the first solar panel 11 may be grasped in advance. Examples of locations where solar panels are installed in vehicles include bonnets, back doors, trunks, and windows in addition to roofs.

The first DCDC converter 12 and the second DCDC converter 22 are configurations for independently controlling power generation of the first solar panel 11 and the second solar panel 21. The first DCDC converter 12 is a power converter. The first DCDC converter 12 receives the electric power generated by the first solar panel 11, converts the input electric power into a predetermined electric power, and outputs the electric power. The first DCDC converter 12 performs control such as converting and outputting generated electric power in accordance with control (instruction) from the first control unit 14. The power of the first DCDC converter 12 is supplied to the battery 30 and the load device 40. The second DCDC converter 22 is a power converter. The second DCDC converter 22 receives the electric power generated by the second solar panel 21, converts the input electric power into a predetermined electric power, and outputs the electric power. The second DCDC converter 22 performs control such as converting and outputting generated electric power in accordance with control (instruction) from the second control unit 24. The output of the second DCDC converter 22, along with the output of the first DCDC converter 12, is supplied in parallel to the battery 30 and the load device 40.

The first sensor 13 and the second sensor 23 are configured to individually acquire the power generation states of the first solar panel 11 and the second solar panel 21. The first sensor 13 can acquire physical quantities such as an output voltage, an output current, a temperature, and generated electric power of the first solar panel 11 as a power generation state of the first solar panel 11. Further, the second sensor 23 can acquire physical quantities such as an output voltage, an output current, a temperature, and generated power of the second solar panel 21 as a power generation state of the second solar panel 21. Various detection elements such as a voltage sensor and a current sensor can be used for the first sensor 13 and the second sensor 23.

The first control unit 14 and the second control unit 24 are configurations for independently controlling the operations of the first DCDC converter 12 and the second DCDC converter 22. The first control unit 14 controls (and instructs) the first DCDC converter 12 based on the power generation status of the first solar panel 11 acquired by the first sensor 13. The control includes control for outputting a voltage command for power generation to the first DCDC converter 12, and MPPT control for performing a scanning process for searching for a maximum power point of the first solar panel 11. The second control unit 24 controls (and instructs) the second DCDC converter 22 based on the power generation status of the second solar panel 21 acquired by the second sensor 23. The control includes control for outputting a voltage command for power generation to the second DCDC converter 22, and MPPT control for performing a scanning process for searching for a maximum power point of the second solar panel 21. A well-known technique can be used for MPPT control of the present embodiment.

The first DCDC converter 12 and the first control unit 14 described above function as a power generation control unit that controls power generation of the first solar panel 11. In addition, the second DCDC converter 22 and the second control unit 24 described above function as a power generation control unit that controls power generation of the second solar panel 21.

The battery 30 is a secondary battery configured to be chargeable and dischargeable, such as a lithium ion battery or a lead storage battery. The battery 30 is connected to the first solar module 10 and the second solar module 20, and is configured to be able to charge the power generated by the first solar panel 11 via the first DCDC converter 12, and to be able to charge the power generated by the second solar panel 21 via the second DCDC converter 22.

The load device 40 is connected to the battery 30, and is a variety of devices that operate with electric power supplied from the battery 30.

The scan control device 50 monitors the power generation state of the first solar panel 11 and the second solar panel 21 in the first solar module 10 and the second solar module 20. The scan control device 50 suitably controls the scan process of MPPT control performed by the first DCDC converter 12 and the second DCDC converter 22. The scan control device 50 is typically configured as an Electronic Control Unit (ECU) including a processor, memories, and input/output interfaces. The scan control device 50 realizes the functions of the determination unit 51 and the instruction unit 52 described below by the processor reading and executing a program stored in the memory.

The determination unit 51 determines whether or not the power generation state of the solar panel satisfies a predetermined condition for each of the first solar panel 11 and the second solar panel 21. Examples of the predetermined condition include that the output voltage of the solar panel is a value in a predetermined range that is estimated to be possible when the solar module is normal, and that the generated power of the solar panel is power that is equal to or higher than a minimum power value that is estimated to be possible in a current solar radiation situation when the solar module is normal. Further, the determination unit 51 may determine the arrival of the timing at which the scanning process is executed in the first solar module 10 and the second solar module 20.

Among the first solar panel 11 and the second solar panel 21, in one of the solar modules, when the determination unit 51 determines that the power generation state of the solar panel does not satisfy a predetermined condition, the instruction unit 52 instructs the control unit of one of the solar modules to control the power generation of the solar panel using the result of the scanning process in the other solar module. For example, when the power generation state of the first solar panel 11 does not satisfy the predetermined condition, the instruction unit 52 instructs the first control unit 14 of the first solar module 10 to control the power generation of the first solar panel 11 using the result of the scanning process in the second solar module 20.

In the case where the solar charging system 1 includes three or more solar modules, if the determination unit 51 determines that there is at least one solar module whose power generation state of the solar panel does not satisfy the predetermined condition, the instruction unit 52 may instruct the solar module that does not satisfy the predetermined condition by transmitting the result of the scanning process in the solar module correlated with the solar radiation situation of the solar panel among the solar modules that satisfy the predetermined condition to the solar module that does not satisfy the predetermined condition.

The control executed by the scan control device 50 will be described in detail below.

### Control

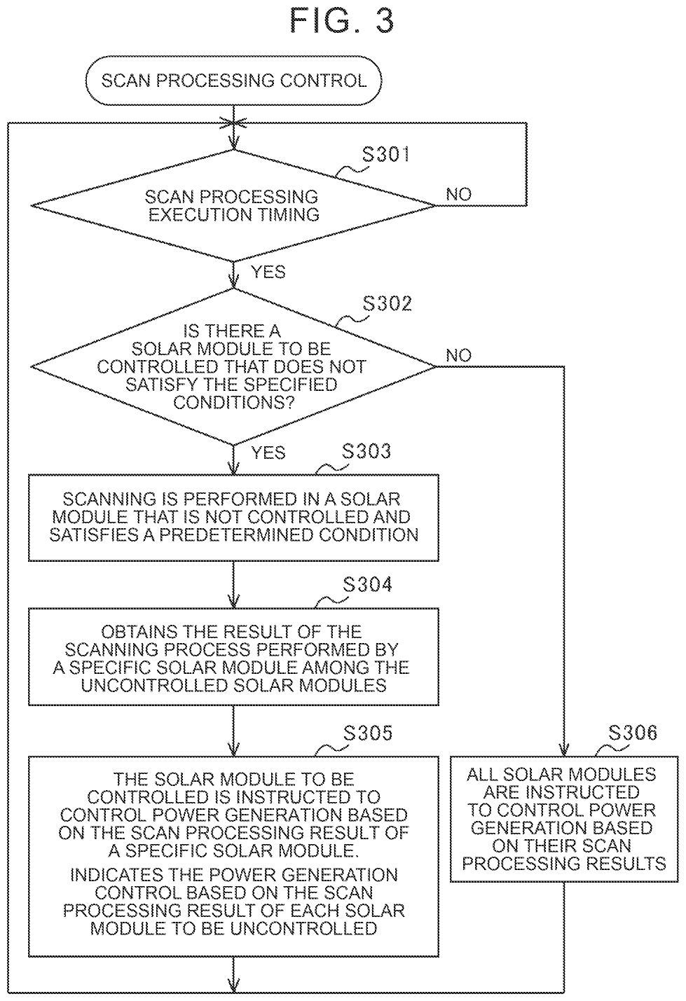

With further reference to FIG. 3, the control performed in the solar charging system 1 comprising a plurality of solar modules will be described. FIG. 3 is a flowchart illustrating a scan process control procedure executed by the scan control device 50 according to the present embodiment. The scan process control illustrated in FIG. 3 is started, for example, when the solar charging system 1 is activated, and is repeatedly executed until the solar charging system 1 is stopped.

### S301

The determination unit 51 of the scan control device 50 determines whether or not the timing for executing the scan process is reached in the plurality of solar modules (including the first solar module 10 and the second solar module 20). This timing can be given in advance in a fixed manner so that the scanning process can be executed periodically. The timing at which the scan process is executed may be notified from the solar module to the scan control device 50 or may be managed by the scan control device 50. When the determination unit 51 determines that the scanning process is to be executed (S301, Yes), the process proceeds to S302.

### S302

The determination unit 51 of the scan control device 50 determines whether or not there is a solar module (hereinafter referred to as a “solar module to be controlled”) in which the power generation state of the solar panel does not satisfy a predetermined condition among the plurality of solar modules. Examples of not satisfying the predetermined condition include a case where the output voltage of the solar panel greatly deviates from a voltage value estimated in advance, a case where the generated power of the solar panel is smaller than a minimum power value estimated in advance, and the like. As illustrated in FIG. 1, when the solar charging system 1 includes two of the first solar module 10 and the second solar module 20, the determination unit 51 may determine whether the power generation state of the solar panel of one of the first solar module 10 and the second solar module 20 does not satisfy a predetermined condition.

When the determination unit 51 determines that there is a solar module in which the power generation status of the solar panel does not satisfy the predetermined condition (S302, Yes), the process proceeds to S303. On the other hand, when the determination unit 51 determines that there is no solar module in which the power generation status of the solar panel does not satisfy the predetermined condition (S302, No), the process proceeds to S306.

### S303

The instruction unit 52 of the scan control device 50 controls (instructs) a solar module (hereinafter, referred to as a “non-controlled solar module”) in which a power generation state of a solar panel other than a solar module to be controlled satisfies a predetermined condition, among a plurality of solar modules, so as to execute a scan process. By this control (instruction), the scanning process of MPPT control is performed in each of the solar modules to be controlled. When the scanning process is performed in the solar module to be uncontrolled according to the instruction of the instruction unit 52, the process proceeds to S304.

### S304

The instruction unit 52 of the scan control device 50 acquires, from a specific solar module, the result of the scan process performed in the specific solar module among the non-controlled solar modules that have performed the scan process. This particular solar module is a solar module that has a correlation to the solar radiation situation with the solar module to be controlled. The correlation with the solar radiation situation is as described above. When the instruction unit 52 acquires the scanning process of a particular solar module, the process proceeds to S305.

### S305

The instruction unit 52 of the scan control device 50 instructs the control unit of the solar module to be controlled to perform the power generation control of the solar panel based on the result of the scan processing of the specific solar module.

Specifically, for example, when the solar panel of the solar module to be controlled and the solar panel of the specific solar module are in a multi-system configuration (FIG. 2A), the instruction unit 52 may instruct the control unit of the solar module to be controlled so that the voltage command value of DCDC converter obtained as the maximum power point in the solar panel of the specific solar module is used as the voltage command value of DCDC converter of the solar module to be controlled. Further, for example, when the solar panel of the solar module to be controlled and the solar panel of the specific solar module have a multi-junction structure (FIG. 2B), the instruction unit 52 can derive a new voltage command value in which the light transmittance, the light attenuation rate, and the like of the solar panel are reflected in the voltage command value of DCDC converter in which the maximum power point is obtained in the solar panel of the specific solar module. Further, the instruction unit 52 can instruct the control unit of the solar module to be controlled so as to use the derived new voltage command value as the voltage command value of DCDC converter of the solar module to be controlled.

On the other hand, the instruction unit 52 of the scan control device 50 instructs the control unit of the solar module that is not to be controlled to perform the power generation control of the solar panel based on the result of the respective scan processes obtained in the respective solar modules.

When the instruction unit 52 instructs the solar module to be controlled and the solar module not to be controlled to control the power generation of the solar panel, the process proceeds to S301.

### S306

The instruction unit 52 of the scan control device 50 instructs the control units of all the solar modules included in the solar charging system 1 to perform the power generation control of the solar panel based on the results of the respective scan processes obtained in the respective solar modules. When the instruction unit 52 instructs all the solar modules to control the power generation of the solar panels, the process proceeds to S301.

Note that, in the above-described process flow, the process of determining the arrival of the timing of executing the scanning process performed by S301 may be performed after the process of determining the presence or absence of the solar module in which the power generation status of the solar panel by S302 does not satisfy the predetermined condition.

Further, in the specific embodiment of S305 in the above-described process flow, it has been described that the instruction unit 52 performs control for directly instructing the voltage command value of DCDC converter that has obtained the maximum power point in the solar panel of a particular solar module without causing the solar module to be controlled to perform the scanning process. However, in addition to this control, for example, when the state of the solar module to be controlled is normal but MPPT control is unstable, the control may be performed by causing the solar module to be controlled to perform a scanning process in which the search range is narrowed or the search interval is widened based on the voltage command of DCDC converter in which the maximum power point is obtained in the solar panel of the particular solar module.

### Operations and Effects

As described above, according to the scan control device according to the embodiment of the present disclosure, when there is a solar module (control target) that does not satisfy a predetermined condition in a plurality of solar modules included in the solar charging system, power generation of the solar panel of the solar module (control target) that does not satisfy the predetermined condition is controlled based on the result of the scan processing in the solar module (specific) that has a correlation with the solar radiation situation with the solar module (control target) that does not satisfy the predetermined condition among the solar modules (control non-target) that satisfy the predetermined condition.

With this control, even if there is a solar module that cannot accurately follow the maximum power point due to an abnormality such as a sensor failing to be used in the solar charging system or an MPPT control becoming unstable ECU the control of the system, it is possible to use a control value measured in another solar module in which the solar radiation condition is similar and the control direction is estimated to be the same for the operation of the solar module. As a result, it is possible to avoid an undesired process in which the scan process is performed in a state of low accuracy, the scan process is frequently performed until a satisfactory result is obtained, or the scan process is continuously performed for a long time due to deterioration in the tracking performance. Therefore, it is possible to suppress a decrease in power generation efficiency of the solar charging system as a whole (improvement in controllability and improvement in power generation amount).

Although an embodiment of the present disclosure has been described above, the present disclosure can be regarded as a scan control device, a solar charging system including a scan control device, a method executed by the scan control device, a program for executing the method, a computer-readable non-transitory recording medium storing the program, a vehicle equipped with a solar charging system including a scan control device, and the like.

The scan control device of the present disclosure can be used in a solar charging system including a plurality of solar modules.

What is claimed is:

1. A scan control device that controls a scanning process in a system in which a plurality of solar modules is connected, the solar modules each including a solar panel, a sensor that acquires a power generation state of the solar panel, and a power generation control unit that controls power generation by the solar panel based on the power generation state of the solar panel, the scanning process being executed by each power generation control unit to search for a maximum power point by scanning an output voltage of each solar panel, the scan control device comprising:
a determination unit that determines whether the power generation state of each solar panel meets a predetermined condition; and
an instruction unit that, when there is a control target solar module for which it is determined by the determination unit that the power generation state of the solar panel does not meet the predetermined condition, instructs the power generation control unit of the control target solar module to control the power generation by the solar panel based on a result of the scanning process for a specific solar module that is different from the control target solar module.

2. The scan control device according to claim 1, wherein:
the sensor acquires the output voltage of the solar panel as the power generation state; and
the predetermined condition includes a condition that the output voltage of the solar panel is a value in a predetermined range taken when a solar module is normal.

3. The scan control device according to claim 1, wherein:
the sensor acquires power generated by the solar panel as the power generation state; and
the predetermined condition includes a condition that the power generated by the solar panel is equal to or greater than a minimum power value taken in a current solar radiation status when a solar module is normal.

4. The scan control device according to claim 1, wherein the specific solar module is a module having a correlation with a solar radiation status with the control target solar module.

5. The scan control device according to claim 4, wherein the control target solar module and the specific solar module are stacked and joined together.
